(19) United States
(12) Patent Application Publication
(10) Pub. No.: US 2023/0177388 A1
(43) Pub. Date: Jun. 8, 2023

(54) VISUALIZATION AND EDITING OF MACHINE LEARNING MODELS

(71) Applicant: INTERNATIONAL BUSINESS MACHINES CORPORATION, Armonk, NY (US)

(72) Inventors: Owen CORNEC, Dublin (IE); Oznur ALKAN, Clonsilla (IE); Rahul NAIR, Dublin (IE); Elizabeth DALY, Dublin (IE)

(73) Assignee: INTERNATIONAL BUSINESS MACHINES CORPORATION, Armonk, NY (US)

(21) Appl. No.: 17/643,333

(22) Filed: Dec. 8, 2021

(51) Int. Cl. G06N 20/00; G06N 5/04

(52) U.S. Cl. CPC G06N 20/00; G06N 5/04

(57) ABSTRACT

Embodiments are provided for enabling visual editing of machine learning models in a computing environment by a processor. A multidimensional dataset may be received. The multidimensional dataset may be processed. Visualization and exploration of an interactive representation of a plurality of datasets and decision boundaries of one or more machine learning models built upon multidimensional dataset are provided. Behavior of the one or more machine learning models may be edited via the interactive representation using one or more logical rules or moving the decision boundaries of one or more machine learning models.

### BACKGROUND OF THE INVENTION

### Field of the Invention

The present invention relates in general to computing systems, and more particularly, to various embodiments for providing visualization and editing of machine learning models in a computing environment using a computing processor.

### Description of the Related Art

In today’s society, consumers, business persons, educators, and others use various computing network systems with increasing frequency in a variety of settings. The advent of computers and networking technologies have made possible the increase in the quality of life while enhancing day-to-day activities. Computing systems can include an Internet of Things (IoT), which is the interconnection of computing devices scattered across the globe using the existing Internet infrastructure. IoT devices may be embedded in a variety of physical devices or products for assisting in improvements to the quality of life and appropriate living accommodations.

### SUMMARY OF THE INVENTION

Various embodiments for enabling visual editing of machine learning models in a computing environment by a processor, are provided. In one embodiment, by way of example only, a method for providing enabling visual editing of machine learning models in a computing environment by a processor. A multidimensional dataset may be received. The multidimensional dataset may be processed. Visualization and exploration of an interactive representation of a plurality of datasets and decision boundaries of one or more machine learning models built upon multidimensional dataset are provided. Behavior of the one or more machine learning models may be edited via the interactive representation using one or more logical rules or moving the decision boundaries of one or more machine learning models.

In addition to the foregoing exemplary method embodiment, other exemplary system and computer product embodiments are provided and supply related advantages.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is an additional block diagram depicting an exemplary functional relationship between various aspects of the present invention;

FIG. 5 is diagram depicting an interactive visual display for providing visualization and editing of machine learning models in which aspects of the present invention may be realized;

FIGS. 6A-6B are diagram depicting various scenarios using the interactive visual display providing visualization and editing of machine learning models in which aspects of the present invention may be realized; and

FIG. 7 is a flowchart diagram depicting an exemplary method for providing visualization and editing of machine learning models in a computing environment by a processor, again in which aspects of the present invention may be realized.

### DETAILED DESCRIPTION OF THE DRAWINGS

In today’s environment, computing system may store and retrieve large amounts of data, which may be in a local, remote, and/or virtualized database. These databases may use a variety of resources, techniques, and applications for processing, storing, analyzing, and visualizing data. For example, these databases store large amounts of data (e.g., petabytes of data). Often times, such computing systems may use a “Big Data” framework to process large amounts of data. That is, “Big Data” is a collection of tools, techniques, and operations used for data sets that becomes so voluminous and complex that traditional data processing applications are inadequate to store, query, analyze or process the data sets using current database management and data warehousing tools or traditional data processing applications.

User feedback is vital to learn new rules/regulations and correct incorrect decision making processes. Decision boundaries of an artificial intelligence (“AI”)/machine learning model may need to change over time in many applications such as, for example, for a loan approval, insurance claim approval, and/or when rules and regulations change over a period of time. Therefore, the decision boundary that classifies a loan/claim application as approved/not can vary over time. It may take time (e.g., days, months, years, etc.) for new data that reflects the new decision rules to accumulate-depending on domains. Due to noise in training datasets, AI models can learn wrong decision boundaries. User feedback is vital in such scenarios to be able to learn new decision boundaries/update the existing boundaries. If users of the AI model and/or the domain experts are enabled to provide feedback on the AI model’s decisions, training datasets can be transformed based on that user feedback and the models can be updated accordingly. Alternatively, a post-processing layer can be implemented on top the existing models to apply the learnt rules.

Moreover, the data itself may be multidimensional such as, for example, a multidimensional dataset relating to healthcare about a patient that may include multiple dimensions such as, for example, age, gender, presence of a disease, any vital statistics. Thus, data visualization and exploration facilitates user engagement and make it easy for users to provide feedback particular for learning and training machine learning models. Data visualization and exploration facilitates users engagement with a computing system. Data visualization and exploration is also a trending visual communication method to communicate complex information in meaningful formats. Currently, due to big data generated by advanced applications data visualization is becoming mandatory to use to take effective and productive decisions. Therefore, visualization can make it easier for users to provide feedback for the decision boundaries of the model and observe the effects of their feedback.

Accordingly, the present invention provides for enabling visual editing of machine learning models in a computing environment. In some implementations, a tabular dataset, a machine learning model, a set of feedback rules (optional) may be used as input data. The present invention processes the data and provides for enabling visual editing of machine learning models with the following functionalities. The present invention, in association with providing visualization and editing of machine learning models, displays decision boundaries of a machine learning model (built on a multidimensional dataset) with respect to multiple dimensions. By providing visualization and editing of machine learning models, user feedback may be collected and received through 1) user specified rules (if-then statements), 2) visual interaction/interface, and/or 3) another application/system connected to the system providing the visualization and editing of machine learning models of the present invention. In some aspects, if a user desire to update the training data with respect to the feedback rules, the present invention 1) creates a new augmented dataset with respect to the feedback rules provided by the user, 2) retrains the machine learning model with the new dataset and displays the new and old decision boundaries (individually and/or together) to the user for comparison.

In some implementations, a multidimensional dataset may be processed. Visualization and exploration of an interactive representation of a plurality of datasets and decision boundaries of one or more machine learning models built upon multidimensional dataset are provided. Behavior of the one or more machine learning models may be edited via the interactive representation using one or more logical rules or moving the decision boundaries of one or more machine learning models.

In some implementations, as used herein, a “decision boundary” may be used and defined for use in a statistical-classification problem for two classes. A decision boundary represents a hypersurface that partitions an underlying vector space into two sets, one for each class. A classifier will classify all the points on one side of the decision boundary as belonging to one class and all those on the other side as belonging to the other class. In some implementations, for multiple classes, the decision boundary is the boundary between different classes or decision regions.

In some implementations, a “dimensionality reduction” (or “Dimensionality reduction” or “dimension reduction”) is the transformation of data from a high-dimensional space into a low-dimensional space so that the low-dimensional representation retains some meaningful properties of the original data, ideally close to its intrinsic dimension. For example, spreadsheet data can be transformed into a matrix of similarity vectors, size N × N with N being the number of rows. This matrix can be reduced to N × 2 giving a two-dimensional (“2D”) map of a data set with N points mapped out.

In some implementations, a boundary builder (e.g., a Voronoi diagram which is a partition of a plane into regions close to each of a given set of objects) may execute an operation to partition a plane given a series of 2D points. Each point is allocated a geometric region in order to fill out the plane. In some implementations, the boundary builder may use a Voronoi diagram to allocate regions to our dimensionally reduced dataset. These regions can be colored by each point’s predicted class, as these merge together decision areas appear. The boundary border between these areas is the approximate decision boundary for the machine learning model.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities, but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

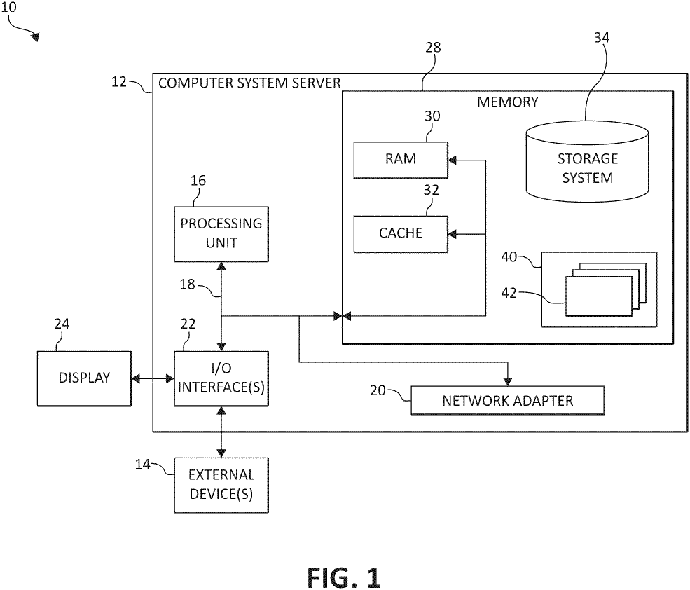

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16 (which may be referred to herein individually and/or collectively as “processor”), a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

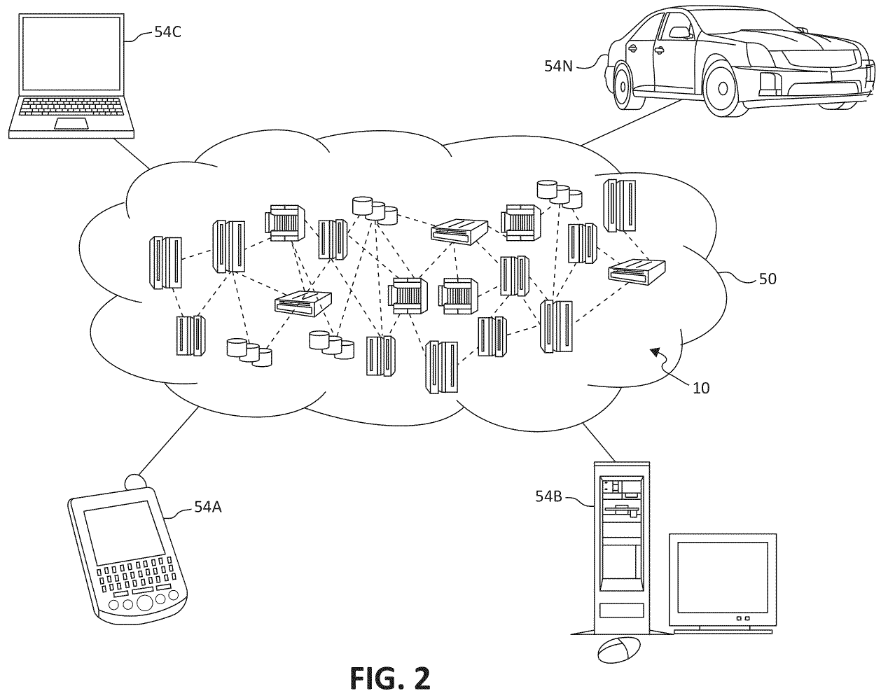

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

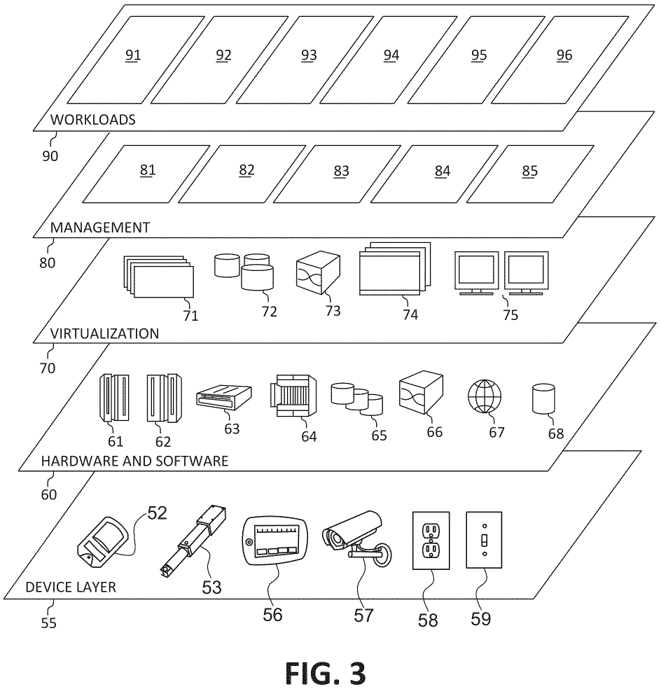

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote-control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for providing visualization and editing of machine learning models. In addition, workloads and functions 96 for providing visualization and editing of machine learning models may include such operations as data analysis, machine learning (e.g., artificial intelligence, natural language processing, etc.), user analysis, feedback data collection, operation and/or analysis, as will be further described. One of ordinary skill in the art will appreciate that the workloads and functions 96 for providing visualization and editing of machine learning models may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, the present invention provides for enabling visual editing of machine learning models in a computing environment by a processor. A multidimensional dataset may be received. The multidimensional dataset may be processed. Visualization and exploration of an interactive representation of a plurality of datasets and decision boundaries of one or more machine learning models built upon multidimensional dataset are provided. Behavior of the one or more machine learning models may be edited via the interactive representation using one or more logical rules or moving the decision boundaries of one or more machine learning models.

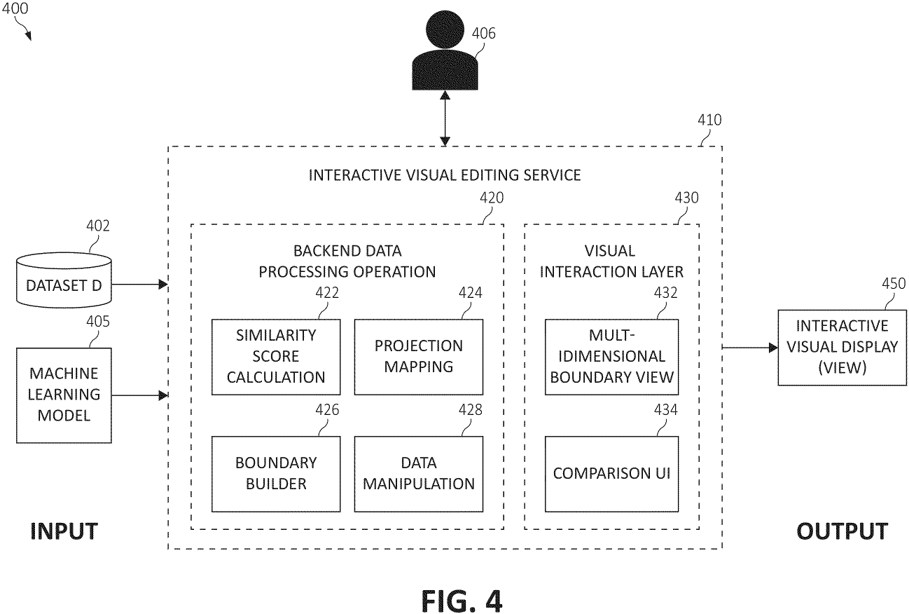

Turning now to FIG. 4 a block diagram depicting exemplary functional components 400 according to various mechanisms of the illustrated embodiments is shown. FIG. 4 illustrates systems 400 for enabling visual editing of machine learning models in a computing environment. As will be seen, many of the functional blocks may also be considered “modules” or “components” of functionality, in the same descriptive sense as has been previously described in FIGS. 1-3. With the foregoing in mind, the module/component blocks 400 may also be incorporated into various hardware and software components of a system for enabling visual editing of machine learning models in accordance with the present invention. Many of the functional blocks 400 may execute as background processes on various components, either in distributed computing components, or on the user device, or elsewhere.

As illustrated in FIG. 4, interactive visual editing service 410 is shown, which may incorporate processing unit 16 (“processors) and memory 28 of FIG. 1 to perform various computational, data processing and other functionality in accordance with various aspects of the present invention. The interactive visual editing service 410 may be provided by the computer system/server 12 of FIG. 1.

As one of ordinary skill in the art will appreciate, the depiction of the various functional units in the interactive visual editing service 410 is for purposes of illustration, as the functional units may be located within the interactive visual editing service 410 or elsewhere within and/or between distributed computing components.

The interactive visual editing service 410 may be in communication with and/or association with one or more user or computing devices 406 (e.g., a computing device such as, for example, a smartphone, smartwatch, desktop computer, laptop computer, tablet, and/or another electronic device that may have one or more processors and memory and configured for sending and receiving data to the interactive visual editing service 410). The computing devices 406 (or user of the computing devices 406) and the interactive visual editing service 410 may each be associated with and/or in communication with each other, by one or more communication methods, such as a computing network, wireless communication network, or other network means enabling communication. In one aspect, the one or more computing devices 406 may be operated by a user for using the interactive visual editing service 410.

In one aspect, the interactive visual editing service 410 may provide virtualized computing services (i.e., virtualized computing, virtualized storage, virtualized networking, etc.) to the one or more computing devices 406. More specifically, the interactive visual editing service 410 may provide, and/or be included in, a virtualized computing, virtualized storage, virtualized networking and other virtualized services that are executing on a hardware substrate.

The interactive visual editing service 410 may also function as a database and/or service that may store, maintain, and update data, services, and/or resources internal to and/or external to a cloud computing environment such as described in FIG. 2. In one aspect, interactive visual editing service 410 may assist in providing access to and/or assist in performing one or more various types of data, services and/or resources. In one aspect, the interactive visual editing service 410 may provide for a backend data operation 420 that may provide a similarity score calculation 422, projection mapping 424, a boundary builder 426, and data manipulation component 428. The interactive visual editing service 410 may provide for a visual interaction layer 420 that provides a multi-dimensional boundary view 432 and a user interface (“UI”) 434 (e.g., a comparison UI). Also, an interactive visual display 450 (e.g., a view) may be in association and/or communication with the interactive visual editing service 410.

For example, computer system/server 12 of FIG. 1 may be used in FIG. 4 and may be connected to other computing nodes over a distributed computing network, where additional data collection, processing, analytics, and other functionality may be realized. The components of the computing system 400 may include, but are not limited to, one or more processors or processing units 16 (“processor”) and/or a system memory 28 of FIG. 1 for executing the interactive visual editing service 410.

The dataset component 402 may include and/or receive from an external source (e.g., external to the interactive visual editing service 410) one or more multidimensional datasets. Also, the multidimensional dataset may be visualized as a matrix having a plurality of dimensions. For example, if a multidimensional dataset has two dimensions, the multidimensional dataset may be visualized as a flat grid. If a multidimensional dataset has three dimensions, the multidimensional dataset may be visualized as a cube. In one aspect, for example, the dataset component 402 may include and/or receive from an external source tabular data.

The interactive visual editing service 410 may receive and use multidimensional dataset 402 and one or more machine learning models 404. The interactive visual editing service 410 may read the multidimensional dataset and the machine learning model 405. The interactive visual editing service 410 may provide visualization and exploration of an interactive representation of the multidimensional dataset 402 and decision boundaries of one or more machine learning models 404 built upon the multidimensional dataset 402. The interactive visual editing service 410 provides and enables editing behavior of one or more machine learning models 404 via the interactive representation (such as, for example, via the interactive visual display 450) using one or more logical rules or moving the decision boundaries of one or more machine learning models 404.

In some aspects, the backend data processing operation 420 may include, for example, the similarity score calculation (e.g., Gowers distance), a projection mapping 424 (e.g., a uniform manifold approximation and projection (“UMAP”) projection) and the boundary builder 426 (e.g., Voronoi diagram) may be used for both displaying the multi-dimensional datasets in 2D view and to be able to display decision boundaries of one or more of the machine learning models 404. In one aspect, the similarity score calculation 422 (e.g., a Gower’s distance) may be used to turn a dataset containing N rows and 2 or more columns into an N ×N matrix of similarity scores. The projection mapping 424 (UMAP projection) may be used to reduce a vector into smaller components, in this case N rows with vectors of N similarity scores will be reduced to N rows with vectors of size 2 (e.g., X and Y coordinates). The boundary builder 426 (Voronoi diagram) may use a 2D coordinate map with N points in order to assign areas to each point and mark/indicate (e.g., color) the points by their predicted class. As these areas merge together, a boundary appears between our two classes.

In some implementations, for editing behavior of the one or more machine learning models, the backend data processing operation 420 and/or the visual interaction layer 430, may include building one or more logic statements of the one or more logical rules. In some implementations, for editing behavior of the one or more machine learning models, the backend data processing operation 420 and/or the visual interaction layer 430, may relabel and generate a training dataset and displaying one or more updated decision boundaries of one or more machine learning models 405.

In some implementations, for editing behavior of the one or more machine learning models 405, the backend data processing operation 420 and/or the visual interaction layer 430, may compare previous decision boundaries with one or more relocated decision boundaries, where both the previous decision boundaries and the one or more relocated decision boundaries are displayed via the interactive representation.

In some implementations, for editing behavior of the one or more machine learning models, the backend data processing operation 420 and/or the visual interaction layer 430, may identify and track each of the changes to the behavior of the one or more machine learning models 405.

In other implementations, the backend data processing operation 420 and/or the visual interaction layer 430 may receive the dataset 402 and one or more feedback decision rules from a user 404 for a plurality of predictions by the one or more machine learning models 405; generate an updated dataset based on the dataset 402 and the one or more feedback decision rules; and move a decision boundary of one or more machine learning models 405 based on the updated dataset.

In other implementations, the backend data processing operation 420 and/or the visual interaction layer 430 may assign similarity scores to a plurality of sectors of the multidimensional dataset; apply a projection mapping operation on the plurality of sectors based on the similarity scores; and build a decision boundary based on the projection mapping operation.

In one aspect, by way of example only, the backend data processing operation 420 and/or the visual interaction layer 430 may provide a visual representation of datasets 402 with 1) the ability to display (e.g., via the interactive visual display 450) any tabular dataset into a two dimensional map of similar clusters, 2) the ability to color 2D points by any column in tabular data to view clusters, 3) the ability to accommodate large datasets with up to 10 thousand (“k”) points.

In another aspect, by way of example only, the backend data processing operation 420 and/or the visual interaction layer 430 may provide visual representation of machine learning models 405 boundaries such as, for example, 1) the ability to display a machine learning model’s 404 decision boundaries by assigning areas to points, 2) the ability to compare and contrast performance measures between the machine learning model 405 versions, 3) the ability to provide a user 406 interpretable summary of changes.

In another aspect, by way of example only, the backend data processing operation 420 and/or the visual interaction layer 430 may provide for editing behavior of the machine learning model 405 behavior. That is, the backend data processing operation 420 and/or the visual interaction layer 430 may build a simple logic statement to change and use the logic statement in to edit the machine learning model 405 behavior. The backend data processing operation 420 and/or the visual interaction layer 430 may be used to relabel and generate a training dataset and show an updated boundary, display and compare boundaries to investigate changes, and/or color points by their changes (relabeled, unchanged, synthetic).

It should be noted that a required data manipulation functionality, which takes as input a dataset, feedback rules, and a machine learning model to generate a new dataset that confirms with the rules, can be achieved through moving decision boundaries of a machine learning model through data manipulation. For example, the interactive visual editing service 410 may receive feedback decision rules for multiple predictions by a trained machine learning model. The interactive visual editing service 410 may provide a feedback rule set based on the feedback decision rules. An updated training dataset may be generated based on an original training dataset and an updated feedback rule set. The updated feedback rule set is not in conflict, and the updated training dataset is configured to train the machine learning model to move a decision boundary. Generating the updated training dataset includes generating multiple updated training instances by applying one of the feedback decision rules to a training instance of the original training dataset.

It should be noted, that in one embodiment, by way of example only, the interactive visual editing service 410 may perform a machine learning operation that may include, for example, an instance of IBM® Watson® such as Watson® Analytics (IBM® and Watson® are trademarks of International Business Machines Corporation). By way of example only, the training/learning component 406 may determine one or more heuristics and machine learning based models using a wide variety of combinations of methods, such as supervised learning, unsupervised learning, temporal difference learning, reinforcement learning and so forth. Some non-limiting examples of supervised learning which may be used with the present technology include AODE (averaged one-dependence estimators), artificial neural networks, Bayesian statistics, naive Bayes classifier, Bayesian network, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher’s linear discriminant, logistic regression, perceptron, support vector machines, quadratic classifiers, k-nearest neighbor, hidden Markov models and boosting.

Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure.

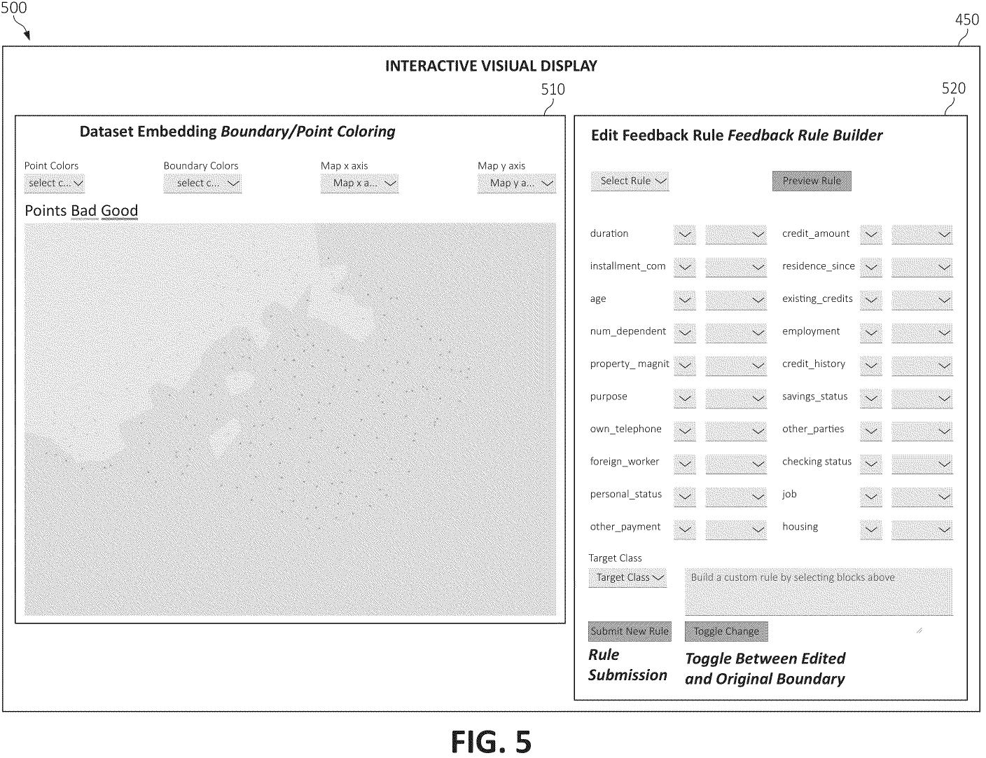

For further explanation, FIG. 5 is diagram depicting an interactive visual display 500 for providing visualization and editing of machine learning models in which aspects of the present invention may be realized. In one aspect, one or more of the components, modules, services, applications, and/or functions described in FIGS. 1-4 may be used in FIG. 5. In one aspect, repetitive description of like elements, components, modules, services, applications, and/or functions employed in other embodiments described herein (e.g., FIGS. 1-4) is omitted for sake of brevity.

For example, the visual interaction layer 430 may be used to provide, via the interactive visual display 450 of FIG. 4, visualization and editing of machine learning models. For example, a dataset embedding (e.g., boundary/point coloring) may be depicted as a multi-dimensional boundary view 510. Additionally, the visual interaction layer 430 may be used to provide a UI 520, via the interactive visual display 450 of FIG. 4, to build a feedback rule and/or enable a user to build, provide, generate, and/or edit a feedback rule. The visual interaction layer 430 enables a user to submit a rule (e.g., “rule submission”) and/or toggle between edited and original decision boundaries. Thus, the visual interaction layer 430 may be used to visualize datasets and a machine learning model decision boundaries, via the interactive visual display 450 of FIG. 4, that allows user to interactively edit model behavior by specifying logical rules or visually editing the boundaries. The interactive visual display 450 provides visualization of the edited model boundaries as it compares edits across models created by user edits.

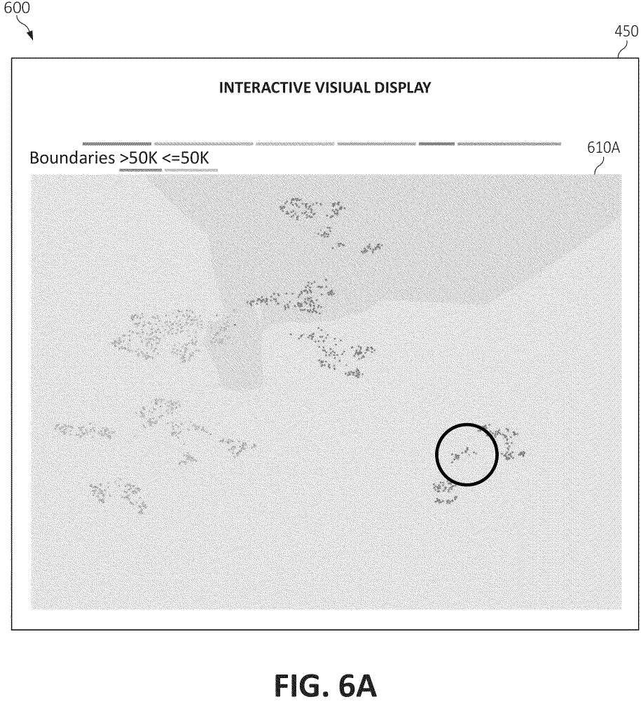

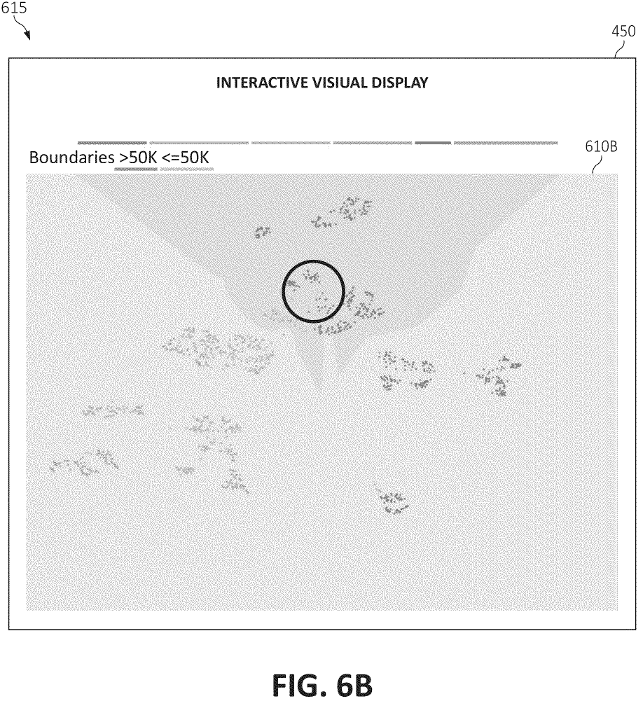

To further illustrate, consider the following examples of FIGS. 6A-6B for diagrams 610A and 610B depicting various examples using the interactive visual display providing visualization and editing of machine learning models. Thus, as depicted in diagrams 610A and 610B, as user in enable to have an immediate view or “initial state”) that is “visual” and “explorable” of the multidimensional data and machine learning model.

For example, consider a scenario, as depicted in diagram 610A using the interactive visual display 450, where a machine learning model is trained and deployed to understand if person will make over or under a particular salary (e.g., $50,000 per year) based on demographics data. A user, deploying the interactive visual editing service 410 of FIG. 4, may generate a multi-dimensional boundary to determine how the machine learning model behaves. In one aspect, a user/expert notices and provides feedback to recolor the map by “relationship” and notices some persons are making below the particular salary (e.g., $50,000 per year) such as, for example, as indicated by the circle in the diagram 610A of the interactive visual display 450.

Turning now to diagram 610B in the interactive visual display 450, the interactive visual editing service 410 of FIG. 4, enables a user to create a new rule (e.g., a feedback rule) such as, for example, “R” is equal to relationship of “persona” AND a class of particular salary (e.g., $50,000 per year). The user may submit the edited rule and a new dataset is generated through the interactive visual editing service 410. That is, the interactive visual editing service 410 may provide data manipulation functionality, which takes as input a dataset, feedback rules, and a machine learning model to generate the new dataset that confirms with the rules. The new boundary from this dataset is updated to reflect that change in model behavior (e.g., the adjusted and relocated circle) and the user verifies the updated decision boundary with the mapping.

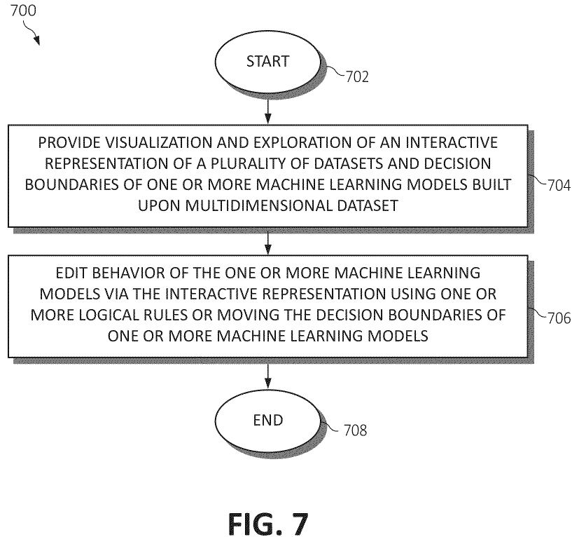

Turning now to FIG. 7, a method 700 for providing visualization and editing of machine learning models in a computing environment is depicted. The functionality 700 may be implemented as a method executed as instructions on a machine, where the instructions are included on at least one computer readable medium or on a non-transitory machine-readable storage medium. The functionality 700 may start in block 702.

A visualization and exploration of an interactive representation of a plurality of datasets and decision boundaries of one or more machine learning models built upon multidimensional dataset may be provided, as in block 704. Behavior of the one or more machine learning models via the interactive representation using one or more logical rules or moving the decision boundaries of one or more machine learning models, as in block 706. The functionality 700 may end in block 708.

In one aspect, in conjunction with and/or as part of at least one block of FIG. 7, the operations of method 700 may include each of the following. The operations of method 700 may include building one or more logic statements of the one or more logical rules. The operations of method 700 may include relabeling and generating a training dataset; and displaying one or more updated decision boundaries of one or more machine learning models.

The operations of method 700 may include comparing previous decision boundaries with one or more relocated decision boundaries, wherein both the previous decision boundaries and the one or more relocated decision boundaries are displayed via the interactive representation.

The operations of method 700 may include identifying and tracking each of the changes to the behavior of the one or more machine learning models.

The operations of method 700 may include receiving a dataset and one or more feedback decision rules for a plurality of predictions by the one or more machine learning models; generating an updated dataset based on the dataset and the one or more feedback decision rules; and moving a decision boundary of one or more machine learning models based on the updated dataset.

The operations of method 700 may include assigning similarity scores to a plurality of sectors of the multidimensional dataset; applying a projection mapping operation on the plurality of sectors based on the similarity scores; and building a decision boundary based on the projection mapping operation.

The operations of method 700 may read the multidimensional dataset, learn the one or more machine learning models using the multidimensional dataset, and train the one or more machine learning models using the using the multidimensional dataset and feedback data/rules.

The operations of method 700 may train, learn, and/or build/construct one or more machine learning models using the dataset and one or more logical rules, wherein the training occurs online, offline, or a combination thereof.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for enabling visual editing of machine learning models by one or more processors comprising:
providing visualization and exploration of an interactive representation of a plurality of datasets and decision boundaries of one or more machine learning models built upon multidimensional dataset; and
editing behavior of the one or more machine learning models via the interactive representation using one or more logical rules or moving the decision boundaries of one or more machine learning models.

2. The method of claim 1, wherein editing behavior of the one or more machine learning models further includes building one or more logic statements of the one or more logical rules.

3. The method of claim 1, wherein editing behavior of the one or more machine learning models further includes:
relabeling and generating a training dataset; and
displaying one or more updated decision boundaries of one or more machine learning models.

4. The method of claim 1, wherein editing behavior of the one or more machine learning models further includes comparing previous decision boundaries with one or more relocated decision boundaries, wherein both the previous decision boundaries and the one or more relocated decision boundaries are displayed via the interactive representation.

5. The method of claim 1, wherein editing behavior of the one or more machine learning models further includes identifying and tracking each of the changes to the behavior of the one or more machine learning models.

6. The method of claim 1, further including:
receiving a dataset and one or more feedback decision rules for a plurality of predictions by the one or more machine learning models;
generating an updated dataset based on the dataset and the one or more feedback decision rules; and
moving a decision boundary of one or more machine learning models based on the updated dataset.

7. The method of claim 1, further including:
assigning similarity scores to a plurality of sectors of the multidimensional dataset;
applying a projection mapping operation on the plurality of sectors based on the similarity scores; and
building a decision boundary based on the projection mapping operation.

8. A system for enabling visual editing of machine learning models in a computing environment, comprising:
one or more computers with executable instructions that when executed cause the system to:
provide visualization and exploration of an interactive representation of a plurality of datasets and decision boundaries of one or more machine learning models built upon multidimensional dataset; and
edit behavior of the one or more machine learning models via the interactive representation using one or more logical rules or moving the decision boundaries of one or more machine learning models.

9. The system of claim 8, wherein editing behavior of the one or more machine learning models further includes building one or more logic statements of the one or more logical rules.

10. The system of claim 8, wherein editing behavior of the one or more machine learning models further includes:
relabeling and generating a training dataset; and
displaying one or more updated decision boundaries of one or more machine learning models.

11. The system of claim 8, wherein editing behavior of the one or more machine learning models further includes comparing previous decision boundaries with one or more relocated decision boundaries, wherein both the previous decision boundaries and the one or more relocated decision boundaries are displayed via the interactive representation.

12. The system of claim 8, wherein editing behavior of the one or more machine learning models further includes identifying and tracking each of the changes to the behavior of the one or more machine learning models.

13. The system of claim 8, wherein the executable instructions when executed cause the system to:
receive a dataset and one or more feedback decision rules for a plurality of predictions by the one or more machine learning models;
generate an updated dataset based on the dataset and the one or more feedback decision rules; and
move a decision boundary of one or more machine learning models based on the updated dataset.

14. The system of claim 8, wherein the executable instructions when executed cause the system to:
assign similarity scores to a plurality of sectors of the multidimensional dataset;
apply a projection mapping operation on the plurality of sectors based on the similarity scores; and
build a decision boundary based on the projection mapping operation.

15. A computer program product for enabling visual editing of machine learning models, the computer program product comprising:
one or more computer readable storage media, and program instructions collectively stored on the one or more computer readable storage media, the program instruction comprising:
program instructions to provide visualization and exploration of an interactive representation of a plurality of datasets and decision boundaries of one or more machine learning models built upon multidimensional dataset; and
program instructions to edit behavior of the one or more machine learning models via the interactive representation using one or more logical rules or moving the decision boundaries of one or more machine learning models.

16. The computer program product of claim 15, wherein editing behavior of the one or more machine learning models further includes building one or more logic statements of the one or more logical rules.

17. The computer program product of claim 15, wherein editing behavior of the one or more machine learning models further includes:
relabeling and generating a training dataset; and
displaying one or more updated decision boundaries of one or more machine learning models; and
comparing previous decision boundaries with one or more relocated decision boundaries, wherein both the previous decision boundaries and the one or more relocated decision boundaries are displayed via the interactive representation.

18. The computer program product of claim 15, wherein editing behavior of the one or more machine learning models further includes identifying and tracking each of the changes to the behavior of the one or more machine learning models.

19. The computer program product of claim 15, further including program instructions to:
receive a dataset and one or more feedback decision rules for a plurality of predictions by the one or more machine learning models;
generate an updated dataset based on the dataset and the one or more feedback decision rules; and
move a decision boundary of one or more machine learning models based on the updated dataset.

20. The computer program product of claim 15, further including program instructions to:
assign similarity scores to a plurality of sectors of the multidimensional dataset;
apply a projection mapping operation on the plurality of sectors based on the similarity scores; and
build a decision boundary based on the projection mapping operation.
